(19) United States
(12) Patent Application Publication
(10) Pub. No.: US 2014/0143726 A1
(43) Pub. Date: May 22, 2014

(54) METHOD OF CHOOSING SOFTWARE BUTTON

(71) Applicant: KUO-PING YANG, Taipei (TW)

(72) Inventors: Anthony Peter Jones, Taipei (TW); Kuo-Ping Yang, Taipei (TW); Ming-Ren Ma, Taipei (TW)

(73) Assignee: Kuo-Ping Yang, Taipei (TW)

(21) Appl. No.: 13/682,913

(22) Filed: Nov. 21, 2012

(51) Int. Cl. G06F 3/0481

(52) U.S. Cl. CPC G06F 3/04817
USPC 715/835

(57) ABSTRACT

A method of choosing a software button is applied on a computer with a touch screen. A plurality of software buttons are displayed on the touch screen. The groups of software buttons/software buttons will be set by turns as one target group of software buttons/target software button. A user touches any place on the touch screen to choose the target group of software buttons/target software button.

### BACKGROUND OF THE INVENTION

1. Field of the Invention

The present invention relates to a method of choosing a software button (when the button is chosen, at least one action will be performed, such as hyperlink, making sound, changing page, changing color for one object, opening a window, etc.), particularly for users who cannot control their hands well.

2. Description of the Related Art

There are often many software buttons or icons within any computer interface for users to choose. Typically able users control the cursor by controlling a mouse to click the software buttons they require. If the computer has a touch screen, the user would generally touch the software buttons required using their fingers.

However, the users who cannot control their hands well may not only be unable or find great difficulty in controlling the mouse but also may also be unable to control their arms, hands and fingers to perform the fine actions required to operate the software buttons. The illustration of the prior arts is shown in FIG. 1, 2, and 3. In prior arts, a special switch 91 is connected to the computer 90, which (as an example) displays nine software buttons A1-A3, B1-B3, and C1-C3, among which A1-A3 are one group, B1-B3 are another group, and C1-C3 are the other group. These software buttons would change their color or shape alternately by grouping. For example, software buttons A1-A3 change their color first, then B1-B3 change their color after two seconds and, at the same time, A1-A3 change their color back to the original color. Software buttons C1-C3 change their color and B1-B3 change their color back to the original color. And then, software buttons A1-A3 change their color and C1-C3 change their color back to the original color. By that methodology, each group of software buttons is constantly “scanned”. For example, when clicking the software button B3, the user presses the special switch 91 by the palm (or forehead, feet or any other body part) after software buttons B1-B3 change their color (as shown in FIG. 1). Then each of the software buttons B1-B3 will change its color in sequence, when the software button B3 changes its color, if the user presses the special switch 91, then the computer 90 knows the software button B3 is selected.

When the computer with a touch screen is not being used, the above method is widely utilised. However, even now computers with a touch screen (such as the Tablet Pad) have become popular, the traditional method, as described, is still been applied accordingly. FIG. 1 and FIG. 2 show the special switches 91 are connected with the tablet PC 90 through a wired connection. FIG. 3 shows the special switches 92 are connected with the tablet PC 90 through a wireless connection (such as the special switch developed by the R.J Cooper company (http://www.rjcooper.com/bluetooth-switch-interface/index.html) which communicates with the IPAD by using Bluetooth).

Even if the computer continues to evolve (and the change is quite fast in this field), the special switches 92 are still being used in this way.

### SUMMARY OF THE INVENTION

The main purpose of the present invention is to provide a method of choosing a software button for the user who has difficulty doing this, with no need (or reducing the need) for the traditional special switch auxiliary.

In order to achieve the above purpose, the method of choosing a software button is used in a computer with a touch screen, comprising:
displaying a plurality of software buttons on a touch screen, the plurality of software buttons being divided into a plurality of groups of software buttons, each of the groups of software buttons including at least one software button;
selecting one group of software buttons from a plurality of groups of software buttons as a target group of software buttons, in which all software buttons are set as the selection state, other software buttons being set as the non-selection state;
receiving a first touch message, which is generated when a user touches the touch screen;
choosing a software button from the target group of software buttons as a target software button, which is set as the selection state, other software buttons being set as the non-selection state;
receiving a second touch message, which is generated when a user touches the touch screen; and
generating an execution message, based on the target software buttons.

### BRIEF DESCRIPTION OF THE DRAWINGS

FIGS. 1 and 2 are the embodiment of the conventional technology.

FIG. 3 is another embodiment of the conventional technique.

FIG. 4 is the drawing of the hardware architecture according to the present invention.

FIG. 5 is the flowchart of the first embodiment according to the present invention.

FIGS. 6, 7, and 8 are the schematic drawing of the software interface of the first embodiment according to the present invention.

FIG. 9 is the flowchart of the second embodiment according to the present invention.

FIG. 10 is the schematic drawing of the software interface of the second is embodiment according to the present invention.

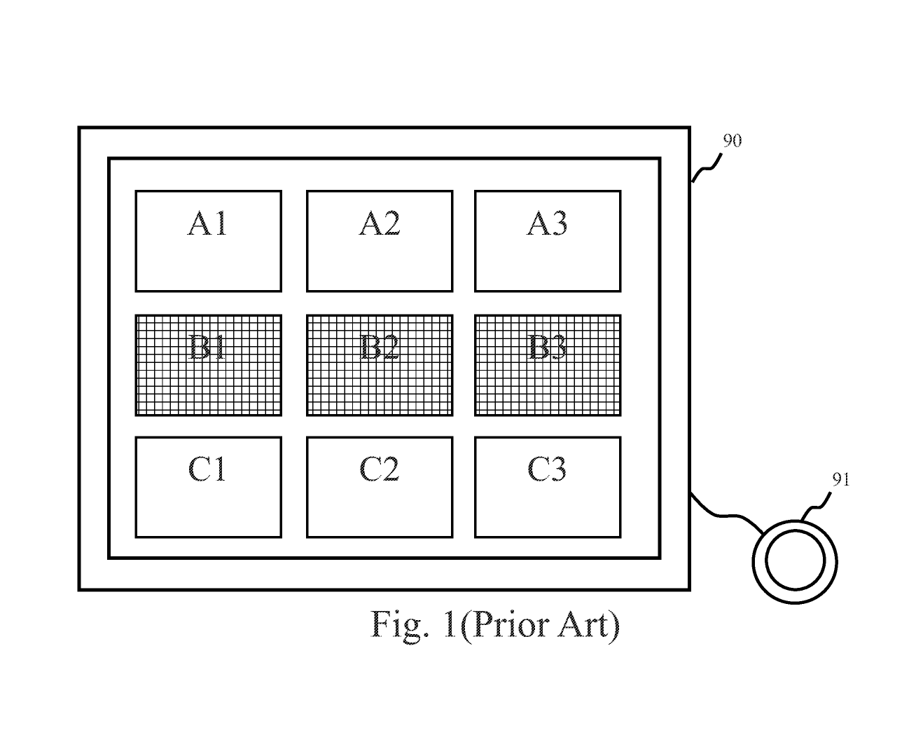

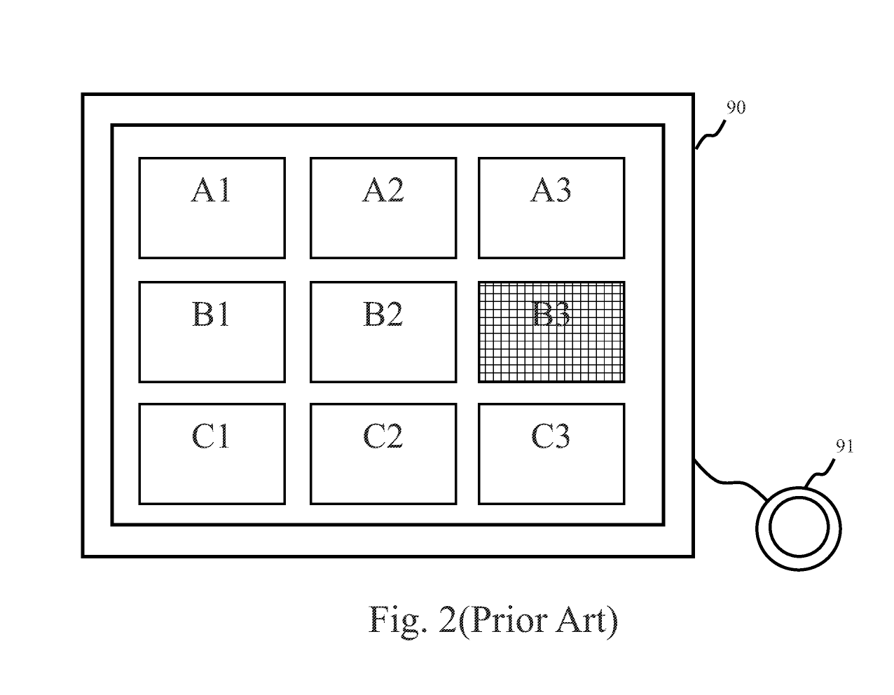

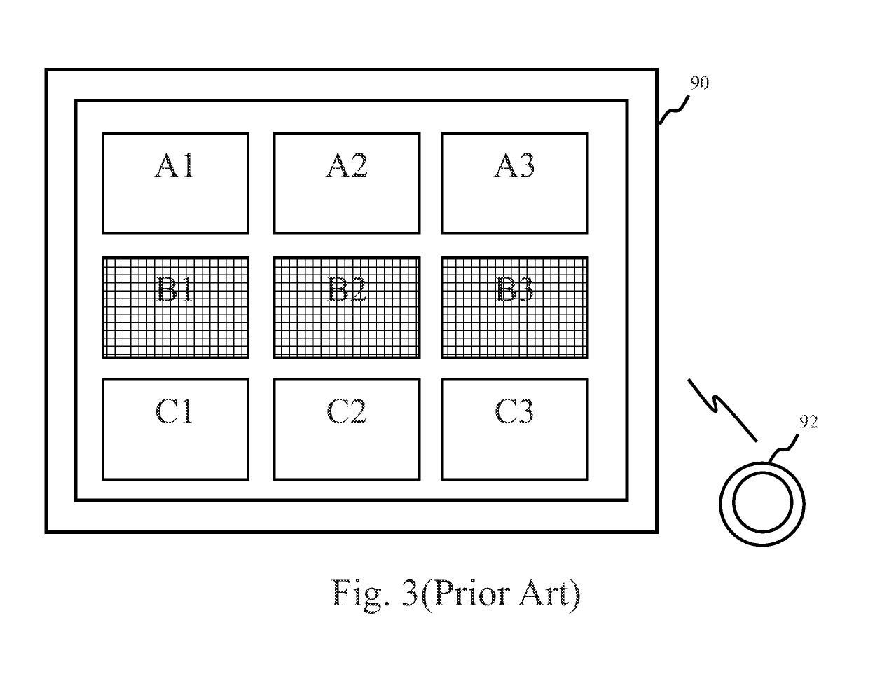

### DETAILED DESCRIPTION OF THE PREFERRED EMBODIMENT

To understand more about the technical content of the present invention, two preferred embodiments will be described as follows.

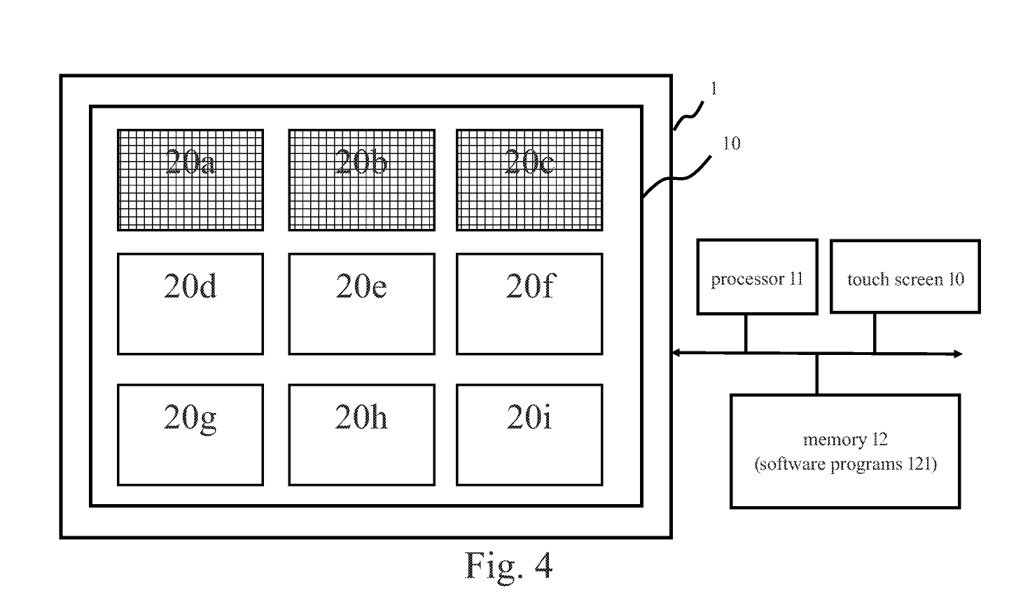

Hereinafter please refer to FIGS. 4 to 8, the description of the first embodiment.

Please refer to FIG. 4, the diagram of the hardware architecture of computer 1 with a touch screen in the present invention. Computer 1 is a tablet PC (PAD) with a touch screen in this embodiment, including a touch screen 10, a processor 11 and a memory 12. The memory 12 is stored with software programs 121, such as system programs, application programs . . . etc. Since the tablet PC is a known technology, it is not described in detail here. In the first embodiment, the touch screen 10 displays nine software buttons 20a-20i, wherein the software buttons 20a-20c are in a group, 20d-20f being in a group, and 20g-20i being in a group.

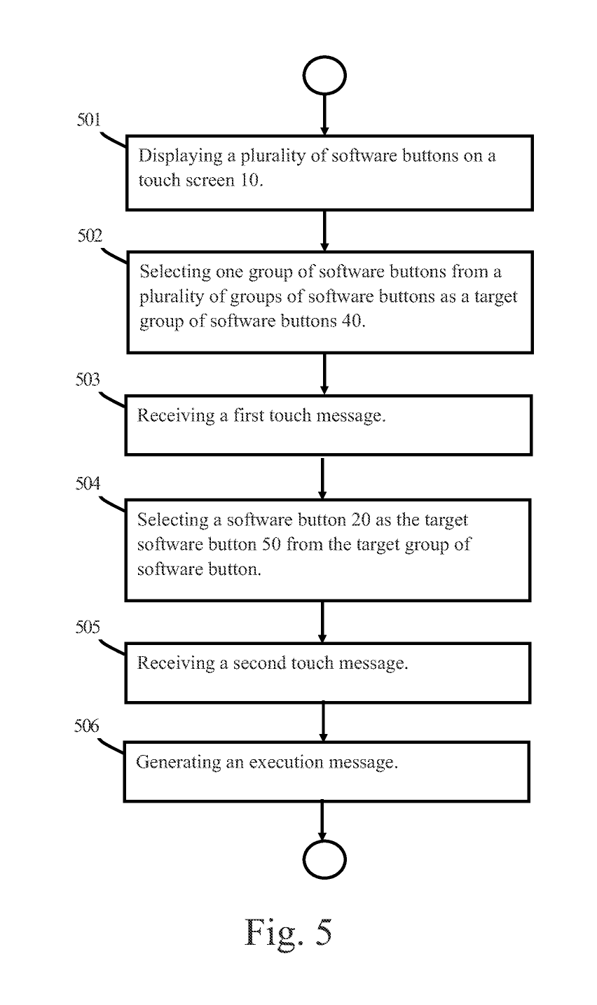

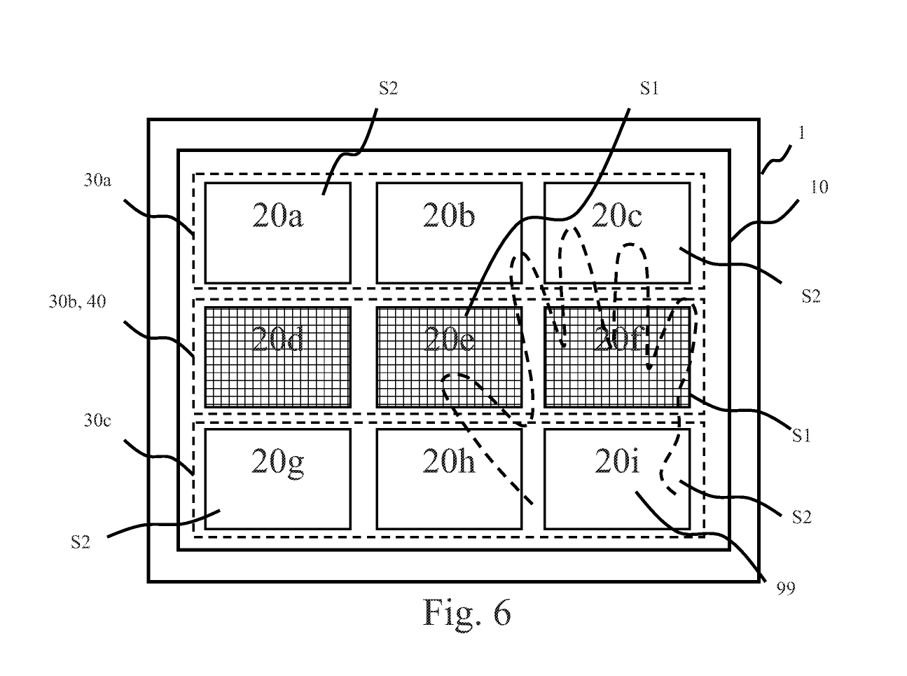

Please refer to FIG. 5, the flowchart of the first embodiment according to the present invention, in which the steps are achieved by the execution of the software program 121 of the processor 11. Please also refer to FIG. 6, 7, and 8, the schematic drawing of the software interface of the first embodiment according to the present invention.

Step 501: Displaying a plurality of software buttons on a touch screen 10, as described in FIG. 4. As shown in FIG. 6, the three groups of buttons of 20a-20c, 20d-20f, and 20g-20i respectively are the groups of software buttons of 30a, 30b, and 30c. For example, the buttons 20a-20c, 20d-20f, and 20g-20i can be used for communications. The groups of software buttons can mark some text or graphics, such as marking “I” on the button 20a, “You” on the button 20b, and “He/She” on the button 20c for the purpose of voice communication, or marking websites, such as “Facebook”, “YouTube”. . . etc., allowing users to connect to the websites.

Step 502: Selecting one group of software buttons from a plurality of groups of software buttons as a target group of software buttons 40. The groups of software buttons 30a, 30b, and 30c will change their color or shape by turns, as shown in FIG. 6, and only one group of software buttons 30b is the target group of software buttons 40. All software buttons of the target group of software buttons 40 are set as the selection state S1, and other groups of software buttons are set as the non-selection state S2. In the example of FIG. 6, the software buttons 20d- 20f in the group of software buttons 30b are set as the selection state S1, and other groups 20a-20c and 20g-20i are set as the non-selection state S2.

As conventional technology, at first the group of software buttons 30a. is the target group of software buttons 40, then the group of software buttons 30b is the target group of software buttons 40, then the group of software buttons 30c is the target group of software buttons 40, and then the group of software buttons 30a is the target group of software buttons 40, and continuing in turn. Also, as conventional technology, the color (or shape) of the software button 20 in the selection state S1 is different from that of the non-selection state S2, so that the user can know which group of software buttons is the target group of software buttons 40.

Step 503: Receiving a first touch message.

In FIG. 6, for example, when the groups of software buttons 30b are as the target group of software buttons 40, the software buttons 20d- 20f are set as the selection state S1. Assumed the user wants to select the software button 20f, so when the group of software buttons 30b becomes the target group of software buttons 40 (FIG. 6), the user touches the touch screen 10 to make the computer 1 receive the first touch message. The user's hand 99 is as shown in FIG. 6. It should be noted that, since it is difficult for the user to precisely control the position of the hand 99, the preferred design is that the user can touch anywhere on the touch screen 10. It should also be noted that it is not necessary for the user to touch the touch screen 10 by hand but by the forehead, feet, elbows, or any other body part.

Step 504: Selecting a software button 20 as the target software button 50 from the target group of software button.

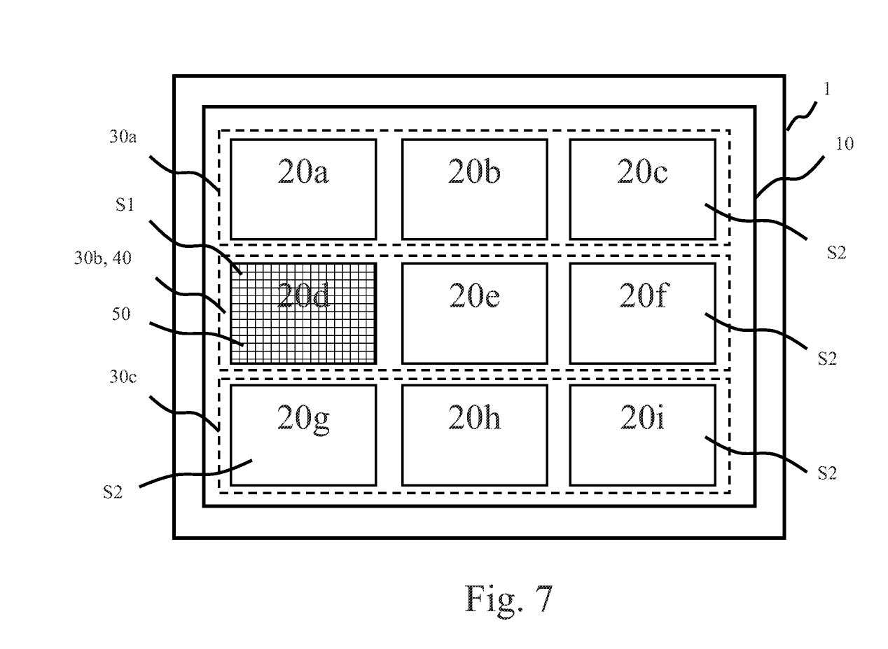

Since in Step 503, the group of software buttons 30b is chosen as the target group of software buttons 40 by the user, the software buttons 20d-20f will change its color or shape by turns (FIG. 7). Please note that only one software button is the target software button 50. Shown in FIG. 7, the software button 20d is the target software button 50 at this moment, which is set in the selection state S1, and other software buttons 20e, 20f, 20a-20c and 20g-20i are set in the non-selection state S2.

Step 505: Receiving a second touch message.

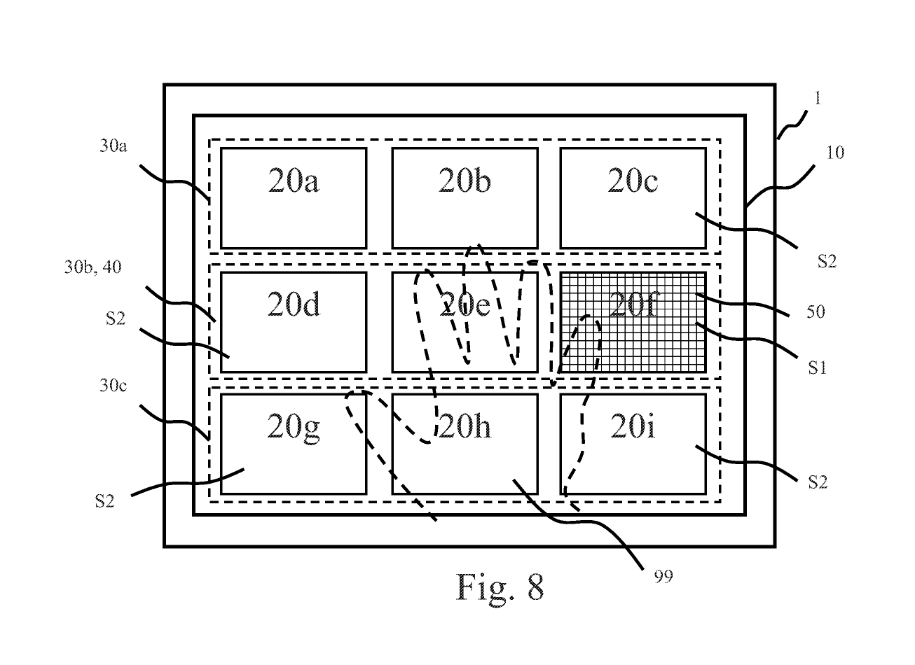

As shown in FIG. 8, when the software button 20f becomes the target software button 50, the software button 20f is set as the selection state S1, and other software buttons are set in the non-selection state S2. Then, the user touches the touch screen 10 (by the hand 99) to make the computer 1 receive the second touch message.

It should be noted that, since it is difficult for the user to precisely control the position of the hand 99, the preferred design is that the user can touch anywhere on the touch screen 10.

Step 506: Generating an execution message.

After the above steps, since the user selects the software button 20f and the software button 20f is selected only, the computer 1 generates an execution message according to the target software button 50 (the software button 20f), such as making sounds, linking to the websites. . . etc.

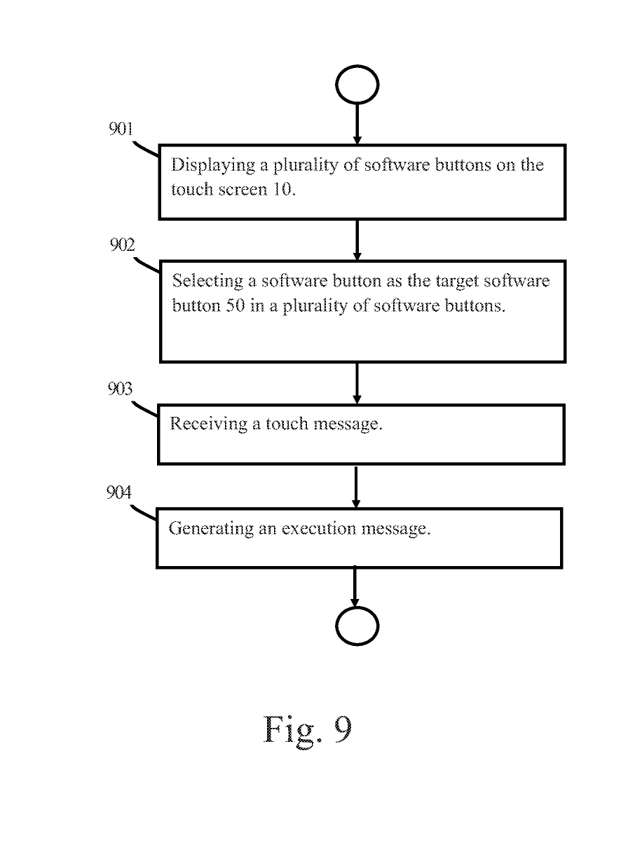

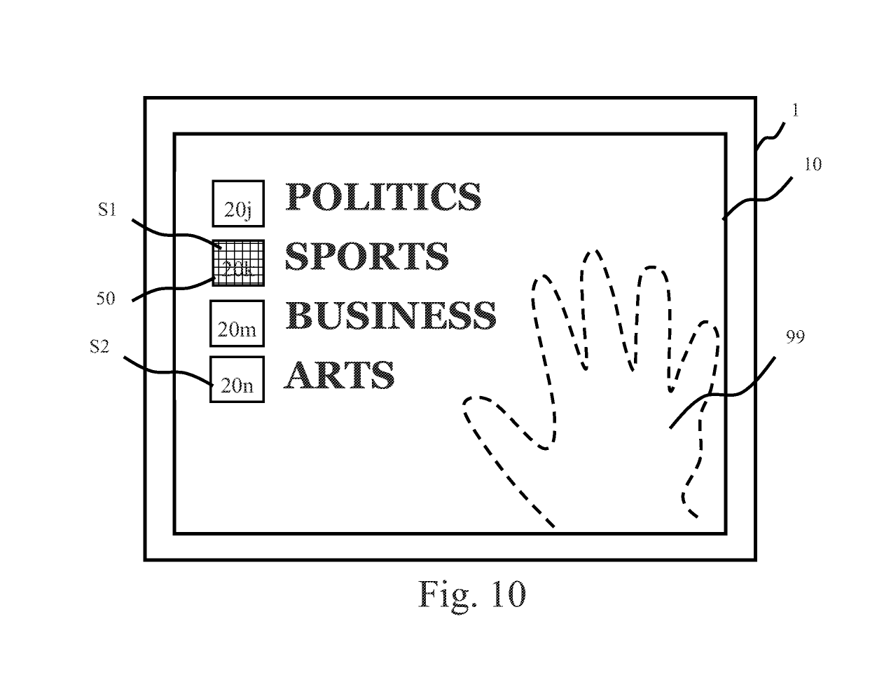

Hereinafter please refer to FIG. 9 and FIG. 10, the description of the second embodiment, The diagram of the hardware architecture is as shown FIG. 4. The second embodiment focuses on software buttons that are not grouped. Software buttons might not be grouped because there are only a small number of software buttons in the software interface or, for some other reason, it is difficult to group software buttons.

Step 901: Displaying a plurality of software buttons on the touch screen 10.

Please refer to FIG. 10, where there are four software buttons, 20j, 20k, 20m, and 20n.

Step 902: Selecting a software button as the target software button 50 in a plurality of software buttons. Likewise, only the target software button 50 is set in the selection state S1 and other software buttons 20 are set in the non-selection state S2. The target software button 50 will be generated in the software buttons 20j, 20k, 20m, and 20n in turns, As shown in FIG. 10, the software button 20k has become the target software button 50 at this moment.

Step 903: Receiving a touch message.

As shown in FIG. 10, when the software button 20k has become the target software button 50, the user touches the touch screen 10 (by the hand 99) to make the computer I receive the touch message.

Step 904: Generating an execution message.

As explained in Step 506, the touch message is produced by touching the touch screen 10 by the user, It should be noted that since it is difficult for the user to precisely control the position of the hand 99, the preferred design is that the user can touch anywhere on the touch screen 10.

Although the present invention has been explained in relation to its preferred embodiments, it is to be understood that many other possible modifications and variations can be made without departing from the spirit and scope of the invention as hereinafter claimed.

What is claimed is:

1. A method of choosing a software button is used in a computer with a touch screen, comprising:
displaying a plurality of software buttons on a touch screen, the plurality of software buttons being divided into a plurality of groups of software buttons, each the group of software buttons including at least one software button;
selecting one group of software buttons from a plurality of groups of software buttons as a target group of software buttons, in which all software buttons are set as the selection state, other software buttons being set as the non-selection state;
receiving a first touch message, which is generated when a user touches anywhere on the touch screen;
choosing a software button from the target group of software buttons as a target software button, which is set as the selection state, other software buttons being set as the non-selection state;
receiving a second touch message, which is generated when a user touches anywhere on the touch screen; and
generating an execution message according to the target software button.

2. The method of choosing a software button as claimed in claim 1, wherein the target group of software buttons will generate by turns in the plurality of the groups of software buttons.

3. The method of choosing a software button as claimed in claim 2, wherein the target software button will generate by turns in the software buttons of the target group of software buttons.

4. The method of choosing a software button as claimed in claim 3, wherein the color of the software button in the selection state differs from that in the non-selection state.

5. The method of choosing a software button as claimed in claim 4, wherein the first touch message and the second touch message are generated by touching anywhere on the touch screen of the user.

6. The method of choosing a software button as claimed in claim 1, wherein the color of the software button in the selection state differs from that in the non-selection state.

7. The method of choosing a software button as claimed in claim 1, wherein the first touch message and the second touch message are generated by touching anywhere on the touch screen of the user.

8. A method of choosing a software button is used in a computer with a touch screen, comprising:
displaying a plurality of software buttons on a touch screen;
selecting one software button from a plurality of software buttons as a target software button, in which the target software button is set as the selection state, and other software buttons are set as the non-selection state;
receiving a touch message, which is generated by touching anywhere on the touch screen of the user; and
generating an execution message according to the target software button.

9. The method of choosing a software button as claimed in claim 8, wherein the target software button will generate by turns in a plurality of software buttons.

10. The method of choosing a software button as claimed in claim 9, wherein the color of the software button in the selection state differs from that in the non-selection state.

11. The method of choosing a software button as claimed in claims 10, wherein the touch message is generated by touching anywhere on the touch screen of the user.

12. The method of choosing a software button as claimed in claim 8, wherein the color of the software button in the selection state differs from that in the non-selection state.

13. The method of choosing a software button as claimed in claims 8, wherein the touch message is generated by touching anywhere on the touch screen of the user.
